(19) United States
(12) Patent Application Publication
(10) Pub. No.: US 2008/0291175 A1
(43) Pub. Date: Nov. 27, 2008

(54) Portable Computer

(76) Inventors: Shekhar Ramachandra BORGAONKAR, Bangalore (IN); Prashanth ANANT, Bangalore (IN); Rahul AJMERA, Bangalore (IN); Praphul CHANDRA, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/109,370

(22) Filed: Apr. 25, 2008

(30) Foreign Application Priority Data
May 23, 2007 (IN) 1082/CHE/2007

(51) Int. Cl. G06F 3/041

(52) U.S. Cl. 345/173

(57) ABSTRACT

Embodiments relate to a portable computer comprising first and second substantially planar portions; the first portion comprising a first output display device of a first size; the second portion comprising a keyboard having a plurality of actuable keys and a touch sensitive display selectively operable as at least one of a further output display device and an input device.

### RELATED APPLICATIONS

Benefit is claimed under 35 U.S.C. 119(a)-(d) to Foreign application Ser. 1082/CHE/2007 entitled “PORTABLE COMPUTER” by Hewlett-Packard Development Company, L. P., filed on 23 May, 2007, which is herein incorporated in its entirety by reference for all purposes.

### BACKGROUND TO THE INVENTION

Embodiments of the present invention relate to portable computers.

Writing is one of the most fluid forms of text entry into a computer system. Computers exist that are able to transform data representing handwriting captured using a tablet or other touch sensitive surface into characters. Typically, a tablet computer, such as a tablet laptop, comprises a rotatable display that can be laid flat relative to and on top of an associated keyboard. A user writes on the tablet screen and the computer converts the writing into graphical output data or text characters.

However, the above is relatively cumbersome as it requires the user to switch the computer between a conventional input mode and tablet mode.

### BRIEF DESCRIPTION OF THE DRAWINGS

Embodiments of the present invention will now be described, by way of example only, with reference to the accompanying drawings in which:

FIG. 1 shows a portable computer according to an embodiment;

FIG. 2 depicts a software architecture according to an embodiment;

FIG. 3 illustrates a state table for influencing the operation of the displays of the portable computer;

FIG. 4 shows a view of the outside housing of a portable computer according to an embodiment;

FIG. 5 depicts use of an embodiment of the portable computer in which a secondary display is used as an input device;

FIG. 6 illustrates use of an embodiment of the portable computer to selectively handle sensitive information

FIG. 7 shows simultaneous display of output data of two applications;

FIG. 8 illustrates a table for directing application display data to an appropriate display;

FIG. 9 depicts a table for directing inputs according to an embodiment;

FIG. 10 shows a further embodiment of a portable computer.

### DETAILED DESCRIPTION

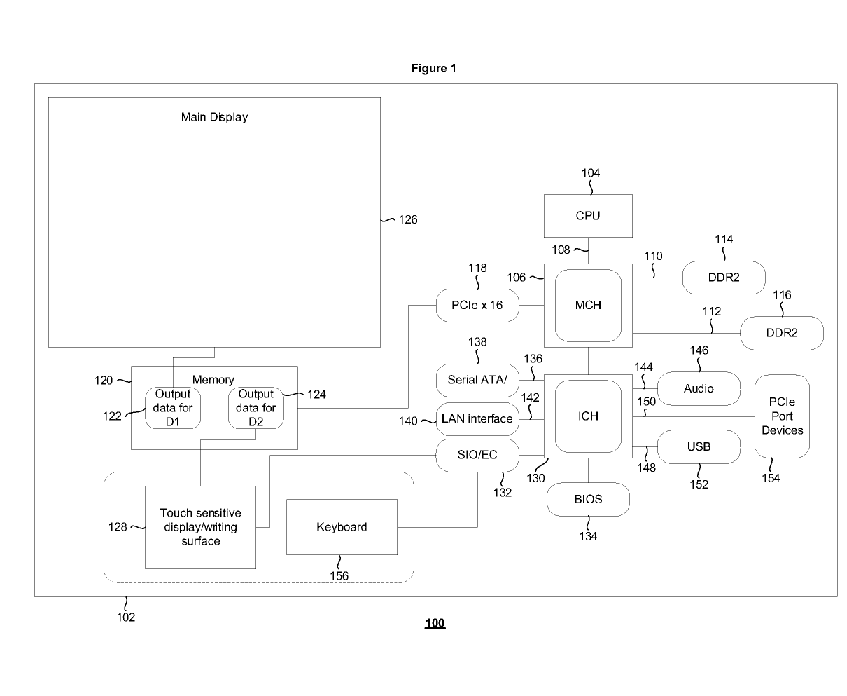

Referring to FIG. 1, there is shown an architecture 100 of a portable computer 102 according to an embodiment of the present invention. The computer 102 comprises a central processing unit (CPU) 104 coupled to a memory controller hub (MCH) 106 via a front side bus 108. The memory controller hub 106 comprises, for example, dual-channel memory support buses 110 and 112 for coupling memory such as, for example, DDR2 667 MHz memory 114 and 116 to the MCH 106. The memory controller hub 106 also comprises an advanced graphics port 118 coupled thereto via a suitable bus such as, for example, PCI express x16. The advanced graphics port 118 has an associated graphics memory 120 for storing output data 122 and 124 to be displayed on a main display 126 and a secondary display 128. The secondary display 128 is also operable as an input device. For example, the secondary display 128 can be a touch sensitive display and is, therefore, coupled to an IO controller hub ICH) 130 via a system input/output 132. The IO controller hub 130 is coupled to a BIOS 134. The IO controller hub 130 may comprise other buses via which other devices can be attached. For example, the IO controller hub 130 may provide a serial advance technology attachment port 136 via which an advance technology attachment 138 may be coupled to the ICH 130. A LAN interface 140 may be coupled to the ICH 130 via, for example, one of a number of PCIe bus ports 142. Furthermore, the ICH 130 may comprise a bus 144 that is coupled to an audio device 146. The IO controller hub 130 may also provide USB 148 and PCI 150 buses for connection to one or more USB devices 152 and one or more PCI devices 154 respectively. The computer 102 comprises a physical keyboard 156 that is coupled to the IO controller hub 130 via the SIO 132.

The above architecture can be realised using an appropriate chipset such as, for example, the Mobile Intel® 945PM Express Chipset in conjunction with an Intel® Core Duo processor and an Intel® 82801 GBM/GHM IO controller hub. The connection can use an Intel® Gigabit Ethernet chip and wireless communication can be realised using an Intel® Pro Wireless chip.

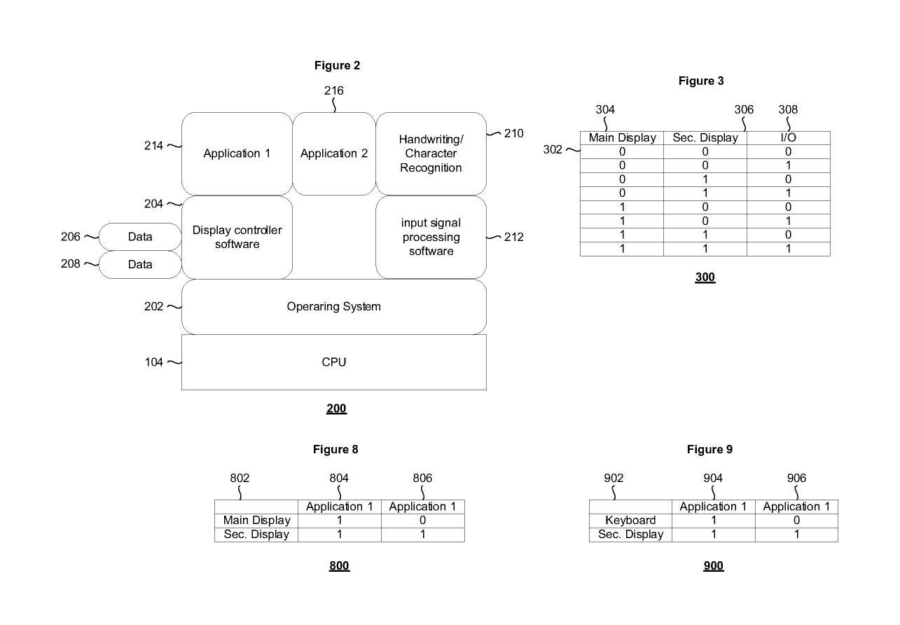

FIG. 2 shows a software architecture 200 according to an embodiment. The CPU 104 is arranged to run an operating system 202 such as, for example, a version of Windows Vista or an open source operating system such as, for example, Linux. The operating system 202 at least supports, or comprises, display controller software 204 that is arranged to access at least one of data 206 and 208 from which the output data 122 for the main display 126 and the output data 124 for the secondary display 128 are derived. The display controller software 204 is arranged to ensure that the data 206 and 208, or at least portions thereof, are displayed on the appropriate displays.

The display controller software 204 is responsive to state information stored within, for example, a state table 300, such as is shown in FIG. 3, that provides an indication to the display controller software 204 of whether or not the displays 126 and 128 are enabled. The table 300 shown in FIG. 3 comprises three columns headed main display 304, secondary display 306 and I/O 308 that govern the operational status of the main display 126 and touch sensitive display 128. A “0” in the column associated with the main display 304 indicates that the main display is disabled such that output data intended for the main display 126 cannot be displayed. A “1” in the column 304 associated with the main display 126 indicates that the main display 126 is enabled and can, therefore, display data such as, for example, output data 206 or output data 122 or data derived therefrom. The same applies to the data stored in the column 306 associated with the touch sensitive display 128. The third column 308 is used to determine whether or not the touch sensitive display is enabled or disabled to operate as an input device. Again, a “0” in this column 308 indicates that the touch sensitive display 128 is not operable as an input device whereas a “1” in the third column 308 indicates that the touch sensitive display 128 is operable as an input device.

Referring again to FIG. 2, there is provided handwriting/character recognition software 210 for converting handwriting produced using the touch sensitive display 128 into corresponding text or characters. There is also provided input signal processing software 212 for processing signals received from the touch sensitive display 128 via the SIO 132 representing user actuation of the touch sensitive display 128 using a digit, stylus or the like, that is, data representing use of the touch sensitive display as an input device. The portable computer can be placed in a mode such that handwriting using, for example, a stylus (not shown) can be captured by using the touch sensitive display 128 as an input device. The captured handwriting can be displayed upon at least one of the main display 126 and the touch sensitive display 128 according to the current display mode dictated, at least in part, by the state information contained within the table 300 shown in FIG. 3. Alternatively, or additionally, the handwriting can be subjected to an analysis using the handwriting/character recognition software to produce corresponding text or characters. It will be appreciated that the handwriting/character recognition software is an example of a converter for transforming data into characters. Furthermore, the handwriting and the text or characters are examples of data associated with an input device such as the touch sensitive display and human readable characters respectively.

FIG. 4 shows an external view 400 of the above described portable computer 102. It can be appreciated that the portable computer comprises housing 402 with a first planar portion 404 that houses the main screen 126. The housing 402 also comprises a second planar portion 406 bearing the physical keyboard 156 and the touch sensitive display 128. It can be appreciated that the touch sensitive display 128 is an embodiment of a secondary or further display. The touch sensitive display 128 and the keyboard 156 are in substantially the same plane, that is, they are substantially co-planar. Having a substantially horizontal touch sensitive display 128 has the advantage that it presents a conveniently orientated writing surface. Furthermore, that the user has simultaneous access to the co-planar keyboard unlike laptops that can be converted into tablet computers.

The display controller software 204 can display the output from the handwriting/character recognition software 210 on at least one of the main 126 and secondary 128 displays according to the display status information contained within the table 300 shown in FIG. 3.

The touch sensitive display 128 can be used to control or influence the operation of at least one of the main display 126 or the touch sensitive display 128. For example, any input operations effected using the touch sensitive display 128 as an input device can be reflected on the main display 126, the touch sensitive display or both at least in part according to the display mode dictated by the status information table 300.

For example, FIG. 5 shows a view 500 of the portable computer 102 in which the touch sensitive display 128 has been used to create drawings 502 effected using, for example, a stylus (not shown). The drawings 502 are displayed on the touch sensitive display 128. The drawings 502 are also reflected simultaneously on the main display 126. Therefore, the current mode of operation of the portable computer 102 is the 8^{th} mode in which the main display 126 is enabled, the touch sensitive display 128 is enabled and the touch sensitive display is enabled as an input device. Equally, any one of the other display modes could be used such that the drawings 502 are selectively displayed on one of the main display 126 and the secondary display 128 with or without the latter being enabled as an input device.

It will be noted that FIG. 2 also shows first 214 and second 216 applications. The applications 214 and 216 can be displayed on respective ones of the main 126 and secondary 128 displays. In this way, the touch sensitive display 128 can be used, for example, to insert annotations and diagrams into a document associated with the application displayed using the main display 128. This situation is depicted in FIG. 5 where the drawings have been inserted into a word processing document 504 displayed using the main display 126. It will be appreciated that two applications have been used merely for illustrative purposes. Embodiments can be realised in which one or more applications can be used.

Additionally, or alternatively, the output data associated with the first 214 and second 216 applications can be displayed on both of the displays 126 and 128 simultaneously. Furthermore, embodiments can be realised in which the output data of one of the applications is displayed on both screens 126 and 128 either exclusively or in conjunction with other data from one or more other applications.

Being able to selectively use one of the displays 126 and 128 allows, for example, the secondary display 128 to be used when a user is at least one of entering and displaying sensitive or private information. For example, if the portable computer 102 is used within an open environment, that is, within an environment in which a person other than the user may see the main display such as, for example, an open plan office, any sensitive data displayed on the main display 126 might be seen by a person other than the user. Therefore, embodiments can be realised in which sensitive data is displayed only on the secondary display 128 thereby ensuring that the sensitive data is not displayed on the main display 126. The selective use of the displays 126 and 128 can be realised by using an application such as, for example, the display controller software 204 for selecting one of the modes of operation shown in table 300. Alternatively or additionally, the portable computer 102 may contain a switch or other actuable member that can be used to select one of the modes of operation described with reference to FIG. 3. Still further, data associated with at least one of an application, web-page, data structure or other software entity or data associated with one of the aforementioned can be detected using the display controller software 204 and, in response to any such detection, used to select an appropriate one of the modes of operation for the two displays 126 and 128. The display controller software 204 is merely one example of a number possible embodiments of the selector for selectively enabling and disabling output of data to the main 126 and secondary 128 displays.

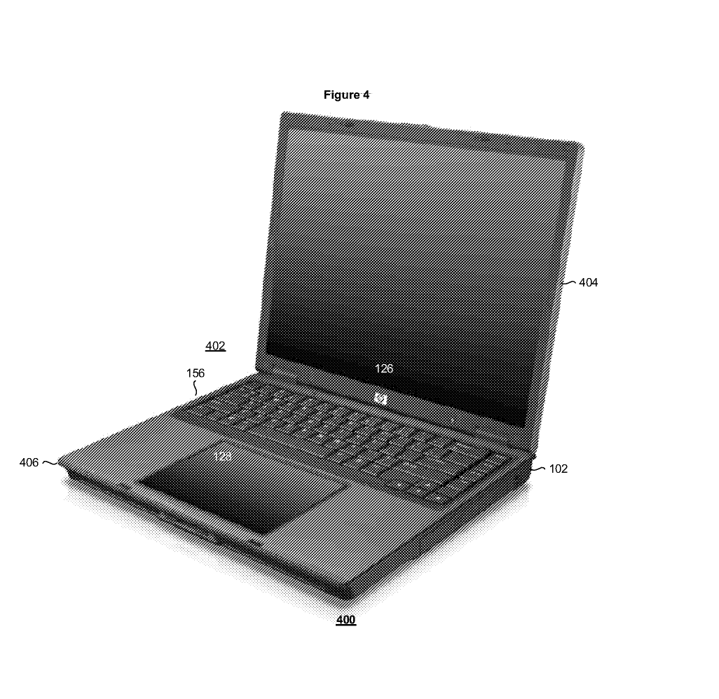

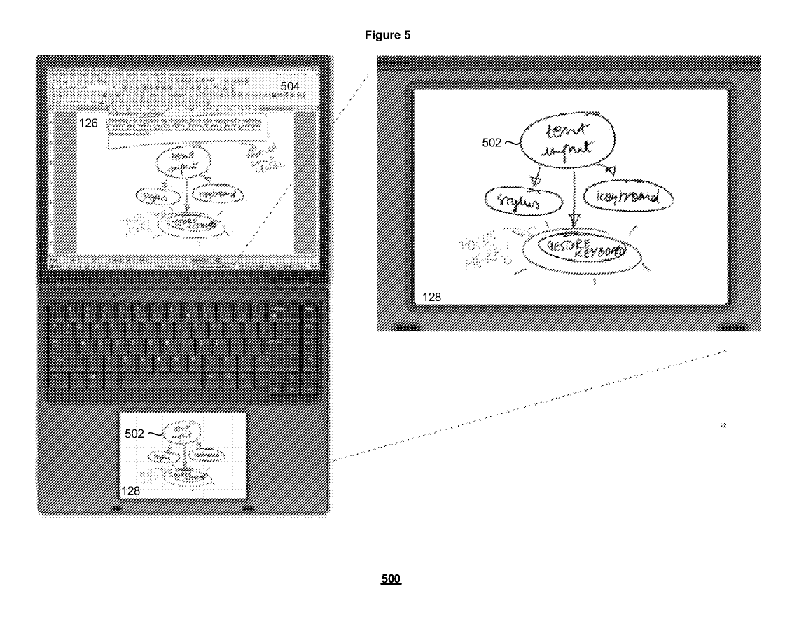

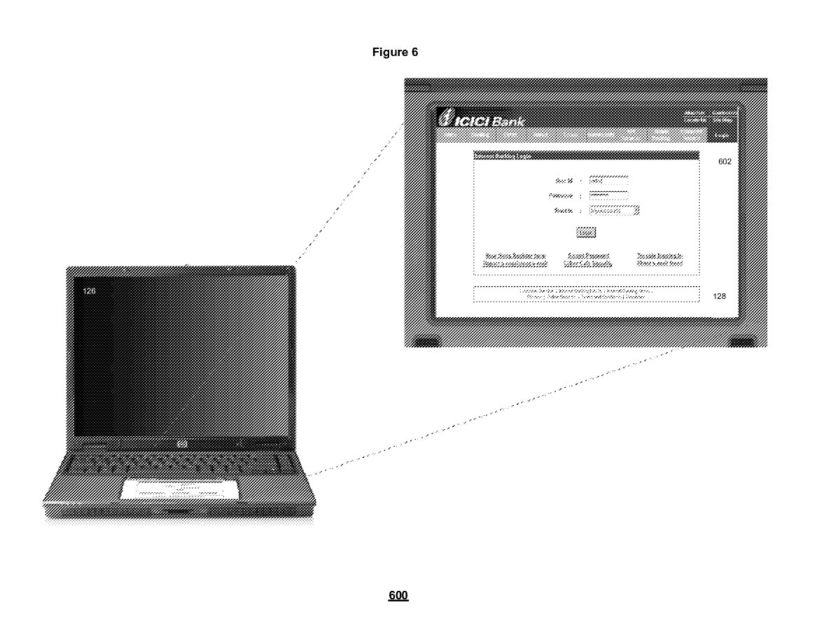

For example, FIG. 6 illustrates a situation 600 in which the portable computer 102 is used in a web banking transaction. The mode of operation has been set to correspond to one of the 3^{rd} and 4^{th} modes of operation in which the secondary display 128 is enabled but the primary display 126 is disabled. The change of mode of operation can be responsive to, for example, detecting “https” within the web-address of the URL associated with the bank (not shown) or associated with a secure page 602 of the bank. Alternatively, any other data can be used to automatically select one of the modes of operation of the computer 102. For example, semantic technology may be used to allow the display controller software 204 to respond to the semantic data associated with a web-page to select the most appropriate operational mode. The semantic data might contain data implying a request for a password. Therefore, the main display 126 can be disabled and the secondary display 128 can be used to display data associated with the sensitive or confidential context of the web application 602. The secondary display can be used to either enter or display sensitive information.

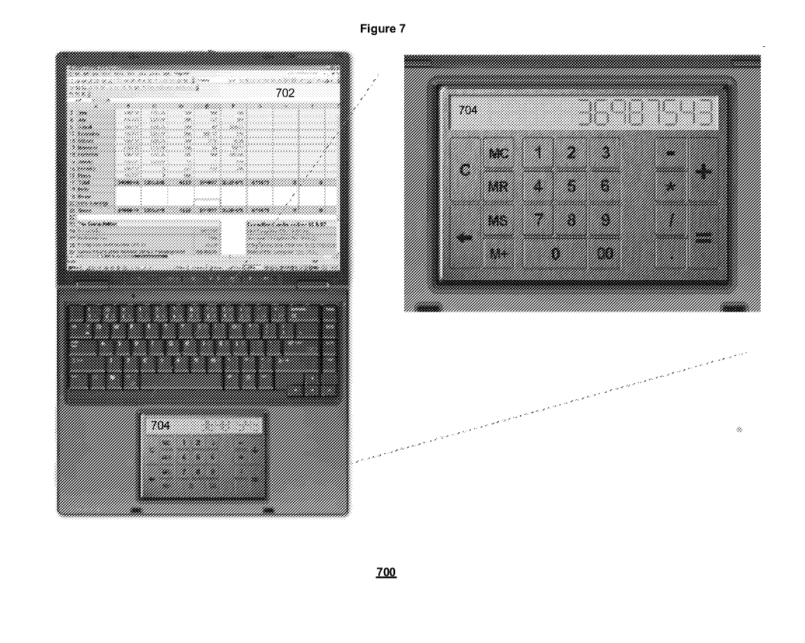

Referring to FIG. 7, there is shown schematically a situation 700 of the use of an embodiment of the portable computer 102 to display the output data associated with the two applications 214 and 216 described above. In the illustrated example, the first application 214 is a spreadsheet 702 whereas the second application is a calculator 704. The display software controller 204 is adapted to direct the output data of the first 214 and second 216 applications to one of the displays according to the current mode of operation of the portable computer described above in relation to table 300. The display controller software maintains a mapping between the displays 126 and 128 and the applications 214 and 216 for controlling the displays used by the applications 214 and 216. FIG. 8 shows an embodiment of such a table 800.

The table 800 comprises a first column 802 having the main and secondary displays as entries. The table 800 comprises at least one or more columns 804 and 806 corresponding to the application or applications that use at least one of the main 126 and secondary 128 displays. In the illustrated embodiments, two such columns are depicted, which correspond to the two applications 214 and 216 of FIG. 2. It can be appreciated that the first application 214 is permitted to use both displays 126 and 128 whereas the second application 216 is permitted to use only the secondary display 128.

When the touch sensitive display 128 is used as an input device, the input signals have to be appropriately directed to or associated with the correct application. Referring again to FIG. 2, the input signal processing software 212 is responsible for mapping inputs made using the keyboard 156 and the touch sensitive display 128 to the appropriate application that is or applications that are currently in-focus on one or more of the displays 126 and 128. It can be appreciated that the inputs from the keyboard might be directed to the first application 214, the second application 216 or both. Appropriately directing the inputs made using at least one of the keyboard 156 and the touch sensitive display 128 can be effected using, for example, a table 900 such as that shown in FIG. 9.

Referring to FIG. 9, there is shown a table 900 showing the mapping between the data generated by the keyboard 156 and the data generated from the touch sensitive display 128 to an appropriate one of the applications 214 and 216. The table 900 comprises a first column 902 having two rows corresponding to the keyboard 156 and the touch sensitive display 128. The table 800 comprises a second column 904 having two rows that contain indications of whether or not the input signals associated with the at least one of the keyboard 156 and the touch sensitive display 216 are associated with the first application 214. The table 800 comprises a third column 906 having two rows that contain indications of whether or not the input signals associated with the at least one of the keyboard 156 and the touch sensitive display 216 are associated with the second application 214. The input signal processing software 212 uses the above table 900 to route the inputs appropriately.

Although the above embodiment described the operation or use of the table 900 using two applications, embodiments are not limited to such a number of applications. Embodiments can be realised in which one or more applications have entries in the table 900.

The touch sensitive display can be used to control a mouse on at least one of the main display 126 and the secondary display 128.

The above embodiments have been described with reference to the first and second applications 214 and 216 being a spreadsheet and a calculator. However, embodiments are not limited to such an arrangement. Embodiments can be realised in which, for example, the secondary display 128 is used to display output data associated with some other application. For example, the other application can be an aspect of Outlook or some other email and diary application. This would allow one skilled in the art to have a diary for the day or some other time period to be visible notwithstanding the main display being used for some other application.

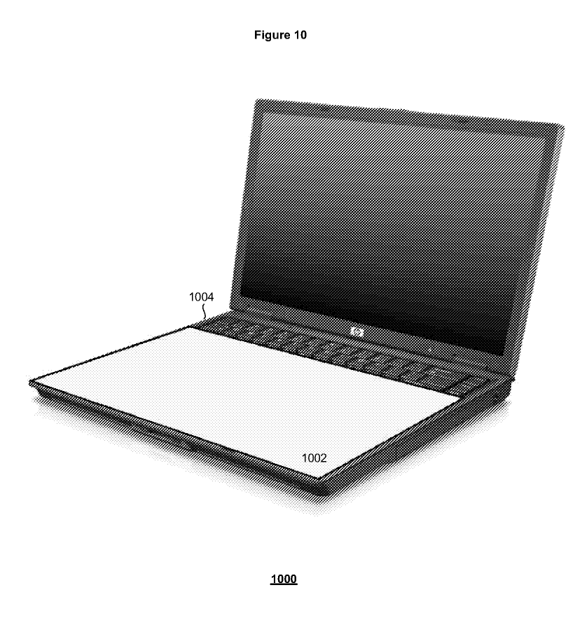

FIG. 10 shows a portable computer 1000 according to a further embodiment. The portable computer 1000 is substantially similar to the portable computer 102 described above and, therefore, only the substantive differences will be described. The portable computer 1000 comprises a relatively large writing surface realised using a touch sensitive surface 1002. Unlike the touch sensitive display 128 described above, the writing surface 1002 is not operable as a display. It merely presents a very convenient writing surface that is co-planer with a plurality of physical keys 1004. The table illustrated in FIG. 3 is adapted for this embodiment to either to remove the column 306 associated with the touch sensitive display 128, thereby retaining only the columns 304 and 308 associated with the main display and the input device, or to merely disable the touch sensitive screen for use as a display by having all zeros in the column 306 associated with the touch sensitive screen.

The above writing surface 1002 can be realised using a touch sensitive whiteboard, that is, the writing surface can be wiped clean after a user has written on it using a pen or the like with the computer being adapted to capture the writing effected using the whiteboard. The computer 102 comprises means to generate input signals corresponding to any writing made on the writing surface. This can be realised using a touch sensitive surface. The writing made on the writing is converted into at least one of graphical output data or text characters corresponding to the writing where appropriate. If the writing or drawing does not correspond to letters and words, the writing manifests itself merely are free-hand graphical data. The text or graphical output data can be displayed on the main display. Suitably, embodiments of the invention comprise means to generate, or a generator to generate, at least one of graphical output data or text output data in response to the writing.

Additionally, or alternatively, the writing surface can also double as a mouse pad or other pointer control input or selection device. Accordingly, the computer comprises means to switch the mode of operation of the writing surface between a writing surface and an input device.

It should be noted that that verb “to write” and all of its conjugations are intended to encompass also the verb “to draw” and all of its conjugations, that is, writing is sufficiently broad to encompass any marks made on the writing surface or any input actions made on the touch sensitive surface or display using any digit, pen, stylus or the like. It will be appreciated that the language “digit, pen, stylus or the like” are embodiments of an actuator via which writing is effected or via which actuation of the touch sensitive surface or display is actuated. Still further, it will be appreciated that writing is merely an example of a free style input.

The touch sensitive input device presents a conveniently orientated writing surface to a user who can use, for example, a stylus or the like, to perform free-hand or free style writing and drawing.

It can be appreciated that embodiments of the present invention have the advantage that writing can be performed simultaneously with typing, that is, one skilled in the art does not have to switch the portable computer between laptop mode and tablet mode.

Having two screens available for displaying data and applications has the tendency to encourage the user to interact with two or more applications substantially simultaneously, without the need to constantly switch between windows or to constantly switch between laptop and tablet modes of operation.

Although the above embodiments have been described with reference to two displays or a main display and a writing surface, embodiments are not limited thereto. Embodiments can be realised in which two or more displays are provided or in which two or more writing surfaces are provided.

Furthermore, embodiments of the present invention can be realised in the form of an input device, such as, for example, a wireless or wired keyboard for a computer that comprises keyboard and co-planar writing surface; the input device comprises means to generate data representing an actuated key of the keyboard and means to generate data associated with any writing made on the writing surface.

1. A portable computer comprising first and second substantially planar portions; the first portion comprising a first output display device of a first size; the second portion comprising a keyboard having a plurality of actuable keys and a touch sensitive device, of a second size, selectively operable as at least one of a further output display device and an input device.

2. A computer as claimed in claim 1 wherein the input device is operable as a mouse or track pad in response to actuation by an actuator.

3. A computer as claimed in any preceding claim in which the input device is operable to influence data output on at least one of the first output display device and the further output display device.

4. A computer as claimed in any preceding claim comprising a selector for selectively enabling and disabling output of data to the first and further output display devices.

5. A computer as claimed in any preceding claim comprising a director for selectively routing output data associated with at least one of first and second applications to at least one the first and further output display devices.

6. A computer as claimed in any preceding claim in which the touch sensitive device is selectively operable as at least one of the further output display device and an input device substantially simultaneously.

7. A computer as claimed in any preceding claim comprising a converter for transforming data associated with the input device into data associated with at least a human readable character.

8. A portable computer comprising first and second substantially planar portions; the first portion comprising a first output display device of a first size; the second portion comprising a keyboard having a plurality of actuable keys and a touch sensitive device, of a second size, operable as input device for capturing free-style inputs.

9. A computer as claimed in claim 8 in which the free-style inputs comprise at least one of handwriting and at least one drawing.

10. An input device comprising a substantially coplanar keyboard and writing surface; the input device comprises means to generate data representing an actuated key of the keyboard and means to generate data associated with any writing made on the writing surface.

11. An input device as claimed in claim 11 in which the writing surface is adapted to bear erasable writing.
